(19) United States
(12) Patent Application Publication
(10) Pub. No.: US 2004/0078729 A1
(43) Pub. Date: Apr. 22, 2004

(54) Method, computer, and computer program for detecting a bad block on a hard disk

(75) Inventor: Gunther Peter, Cadolzburg (DE)

Correspondence Address: SCHIFF HARDIN, LLP, PATENT DEPARTMENT, 6600 SEARS TOWER, CHICAGO, IL, 60606-6473, US

(73) Assignee: Siemens Aktiengesellschaft

(21) Appl. No.: 10/180,717

(22) Filed: Jun. 26, 2002

(51) Int. Cl. G06F 11/00

(52) U.S. Cl. 714/54

(57) ABSTRACT

In a method for detecting a bad block of a first computer's hard disk, the registry of the Microsoft Windows® operating system with which the first computer is configured is modified. Based on the modified registry of the Microsoft Windows® operating system, the hard disk is automatically scanned for bad blocks when the first computer's Microsoft Windows® operating system is booted. The result of the scan is stored in a file associated with the first computer. If at least one bad block is detected, then a message containing information about the bad block is generated at the first computer and conveyed over a communication network to a second computer.

### BACKGROUND OF THE INVENTION

1. Field of the Invention

The invention relates to automated detection of a bad block on a hard disk.

2. Description of the Prior Art

The purpose of monitoring a network is to manage network performance, discover and solve network problems, and plan for network growth. According to Morris Sloman (Editor), “Network and Distributed Systems Management”, Addison-Wesley, England, 1994, pg. 303, monitoring can be defined as the process of dynamic collection, interpretation, and presenting of information concerning objects or software processes under scrutiny. Monitoring can be used for general network management, such as performance management, configuration management, fault management, or security management. One application of monitoring is event reporting which is explained below using definitions taken from the aforementioned text at pp. 303 to 347.

The network to be monitored is comprised of one or more managed objects. A managed object is defined as any hardware or software component whose behavior can be monitored or controlled by a management system. Hardware components may be hubs, routers, computers, bridges, etc.. Each managed object is associated with a status and a set of events. The status of a managed object is a measure of its behavior at a discrete point in time. An event is defined as an atomic entity which reflects a change in the status of the managed object. The behavior of the managed object can be defined and observed in terms of its status and events.

The status of the managed object lasts for a certain time period. Examples of a status are “process is idle” or “process is running”. An event occurs instantaneously. Examples of an event are “message sent” or “process started”. Since the status of an managed object is normally changing continuously, the behavior of the managed object is usually observed in terms of a distinguished subset of events, called events of interest. Events of interest reflect significant changes in the status of the managed object.

In order to monitor the events of interest, events of interest must be detected. An event is said to have occurred when the conditions which are defined by event detection criteria are satisfied. These conditions are detected by appropriate instrumentation, such as software and hardware probes or sensors inserted in the managed object.

Event detection may be internal within or external from the managed object. Internally performed event detection is typically performed as a function of the managed object itself. Externally performed event detection may be carried out by an external agent which receives status reports of the managed object and detects changes in the status of the managed object.

The occurrence of the event may be detected in real-time or delayed. Once the event is detected, an event report is generated at the managed object. The event report may comprise an event identifier, type, priority, time of occurrence, the status of the managed object immediately before and after the occurrence of the event, and other application-specific status variables.

In order to monitor the dynamic behavior of the managed object, the event report may be conveyed from the managed object to a central unit. At the central unit event reports may be gathered, visualized, and recorded. The central unit may be a Network Management Station (NMS) on which an appropriate software, usually called a manager, resides. The manager executes management applications that monitor and control the managed objects. Physically, an NMS, sometimes called a console, is usually an engineering workstation with a fast CPU, megapixel color display, substantial memory, and abundant disk space. The NMS may comprise a database on which incoming reports sent by the managed objects, such as event reports, are stored.

Received reports can be viewed with the Graphical User Interface (GUI) of the NMS.

One particular event of interest may be the occurrence of a bad block on a hard disk. If the hard disk has a bad block, then it is at least partly defective. If the computer is configured with a Microsoft Windows® operating system, such as Windows NT®, Windows 2000®, or Windows XP®, then a bad block on its hard disk cannot automatically be detected, and a result of this is a limited monitoring of that computer's hardware. According to the state of the art, it is possible only to manually check the hard disk by utilizing an appropriate tool of the Microsoft Windows® operating system. In addition, it is necessary to reboot the computer, if the check of the hard disk is to be completed. If the operating system is, for instance, Microsoft Windows NT®), then this tool is the “disk manager”. FIGS. 1 to 3 illustrate the manual steps a person has to carry out when initiating the disk manager.

When initiating the disk manager, a window 10, as shown in FIG. 1, is displayed on the screen connected to the computer. Since the hard disk will be checked for bad blocks, a field 11 labeled “Check Now . . . ” of window 10 has to be activated, for example with a computer-mouse connected to the computer. After that a window 20, as depicted in FIG. 2, appears on the screen. Then the option “Automatically fix filesystem errors” 21 has to be marked and the button 22 of window 20 has to be activated. After activating button 22 which is labeled “Start”, a window 30 which is shown in FIG. 3 appears on the screen. In order to continue the check of the hard disk, button 31 of window 30 has to be activated and the computer has to be restarted.

### SUMMARY OF THE INVENTION

It is an objective of the present invention to provide a method which enables automated detection and reporting of a hard disk's bad block if its related computer is configured with a Microsoft Windows® operating system. The Microsoft Windows® operating system shall not be based on DOS, such as Microsoft Windows 95®.

Another objective of the present invention is to provide a computer which is run by a Microsoft Windows® operating system and is configured to automatically detect and report a bad block of its associated hard disk.

A further objective of the present invention is to provide a computer program which enables the relative easy configuration of a computer which will automatically detect a bad block of the computer's hard disk. The computer is configured with a Microsoft Windows® operating system.

The above objective is achieved in accordance with the invention by means of a method comprising the steps of: booting a first computer which is run by a Microsoft Windows® operating system; automatically initiating a scan for bad blocks of a hard disk which is associated with the first computer, based on a modified registry of the Microsoft Windows® operating system of the first computer, reporting the result of the scan in a file associated with the first computer; generating, at the first computer, a message containing information about a bad block if a bad block is reported in the file related to the Microsoft Windows® operating system; and sending the message to a second computer over a communication network.

According to the inventive method the first computer's registry of the Microsoft Windows® operating system is modified so that the scan of the hard disk is automatically initiated when the operating system is booted. The operating system may be booted by turning on or restarting the first computer. The scan is performed by an in-built function of the operating system. The result of the scan may be reported in the Microsoft Windows® operating system's system logfile or in a file defined by a user of the first computer.

Should the scan find a bad block on that file, then the message containing information about the bad block is generated at the first computer and conveyed over the communication network to the second computer. Consequently, the hard disk of the first computer is remotely monitored by the second computer.

In a restricted version of the inventive method, the second computer monitors the first computer with an agent-manager network management system, so that the message is an event report generated by the agent-manager network management system. The agent-manager network management system is comprised of a manager, which is software residing at the second computer which may be a Network Management Station (NMS), and one or more agents. An agent is software residing at managed objects monitored by the NMS. The first computer is then configured with an agent and is also a managed object monitored by the NMS. The agent is configured to generate and send the event report to the manager. Network management systems are commercially available. Examples of network management systems are HP OpenView, IBM NetView, and Novel NetWare.

The inventive method can particularly be used for computers which are configured with Windows 2000®, Windows XP®, or Windows NT® operating systems. The inventive method is, however, applicable to any Microsoft Windows® operating system which are not based on DOS. This specifically includes any future releases of a Microsoft Windows® operating system which is comparable to Microsoft Windows NT®, Windows 2000®, or Windows XP®.

The objective is also achieved in accordance with the present invention with a first computer which is monitored by a second computer through a communication network. The first computer is configured with a Microsoft Windows® operating system. The registry of the first computer's Microsoft Windows® operating system is modified, so that a function of the Microsoft Windows® operating system is automatically initiated when booting the first computer's Microsoft Windows® operating system. This function is designed to scan a hard disk associated with the first computer for bad blocks. In addition, the first computer is configured to generate a message if at least one bad block of the hard disk is detected during the scan. Furthermore, the first computer is configured to convey the message which comprises information about at least one bad block to the second computer over the communication network.

In a more restricted version of the invention, the first computer may be configured with an agent and the second computer may be configured with a manager, so that the message is an event report generated by the agent. Then the second computer may be a Network Management Station (NMS) which monitors the first computer, which may be then a managed object. If the result of the scan is reported on the logfile of the Microsoft Windows® operating system, then the agent of the first computer is configured to check the logfile and generate an event report when the logfile has information about at least one bad block of the hard disk. The event report is then conveyed from the agent of the first computer over the communication network to the manager of the second computer. Consequently, if the invention is used in combination with an agent-manager Network Management System, then remotely monitoring a hard disk of a computer which is configured with a Microsoft Windows® operating system can be achieved in a relatively convenient way.

The Microsoft Windows® operating system may be Windows 2000®, Windows XP®, or Windows NT®. The invention is, however, not restricted to Microsoft Windows 2000®, Windows XP®, or Windows NT® operating systems. The invention is generally applicable to Microsoft Windows® operating systems, including future releases and modifications, as long as they are not based on DOS.

The above objective is also achieved in accordance with the invention by means of a computer program for configuring a computer run by a Microsoft Windows® operating system. The computer program is designed to modify the registry of the Microsoft Windows® operating system with at least one entry, so that the operating system automatically initiates a scan of the computer's hard disk for bad blocks when the Microsoft Windows® operating system is booted. The computer program is further designed to record the result of the scan in a file associated with the computer.

### DESCRIPTION OF THE DRAWINGS

FIGS. 1 to 3, as discussed above, illustrate how to manually check a hard disk of a computer which is configured with a Microsoft Windows® operating system.

FIG. 4 is a pictorial diagram of a computer being monitored by another computer.

FIGS. 5 and 6 show entries in the registry of a computer configured with Windows NT®.

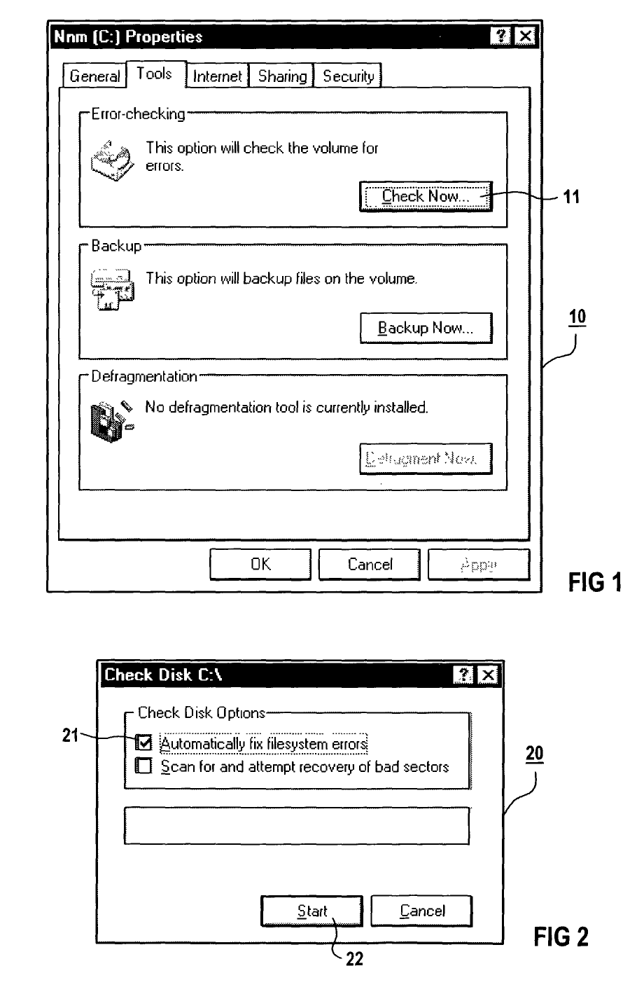

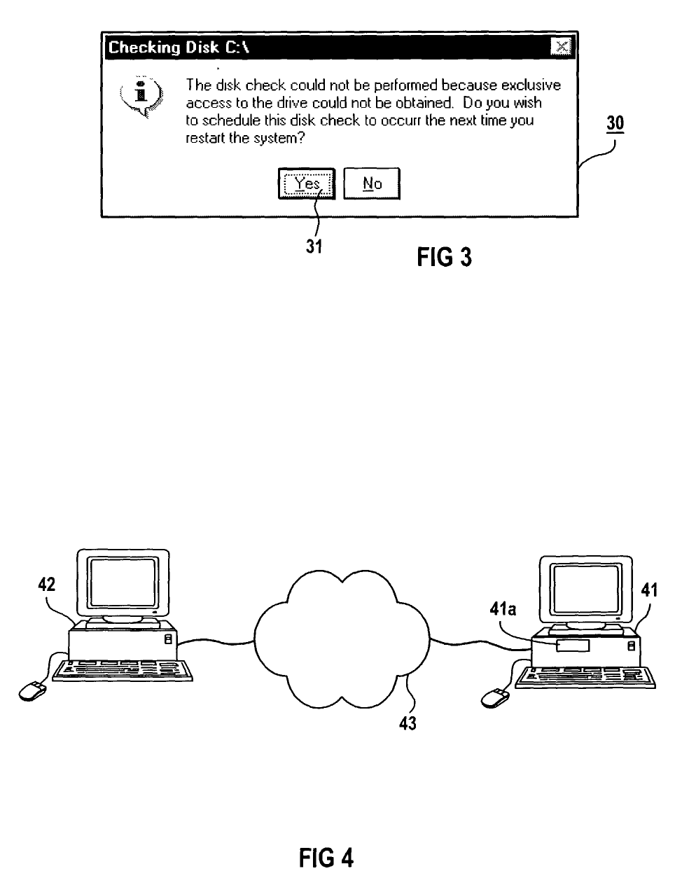

### DESCRIPTION OF THE PREFERRED EMBODIMENTS

FIG. 4 shows a computer 41 which is monitored by a Network Management Station (NMS) 42 over a communication network 43. The NMS 42 is physically a computer and monitors computer 42 using the agent-manager network management system HP OpenView for this exemplary embodiment. On the NMS 42 resides a manager which communicates with an agent residing on computer 41. The manager is software configured to receive reports sent by the agent. The agent is software configured to control and detect significant changes in the status of computer 41 according to a predefined set of event detection criteria. In the present exemplary embodiment, one event detection criterion is the occurrence of at least one bad block of computer 41's hard disk 41a.

Computer 41 is configured with a Microsoft Windows® operating system. The operating system is Windows NT® for the exemplary embodiment. Computer 41 can also be configured with any Microsoft Windows® operating system as long as it is not based on DOS, like Windows 95®. Thus, computer 41 also can specifically be configured with Windows 2000®, Windows XP®, or any future release of a Microsoft Windows® operating systems which is comparable to Windows NT®, Windows 2000®, or Windows XP®.

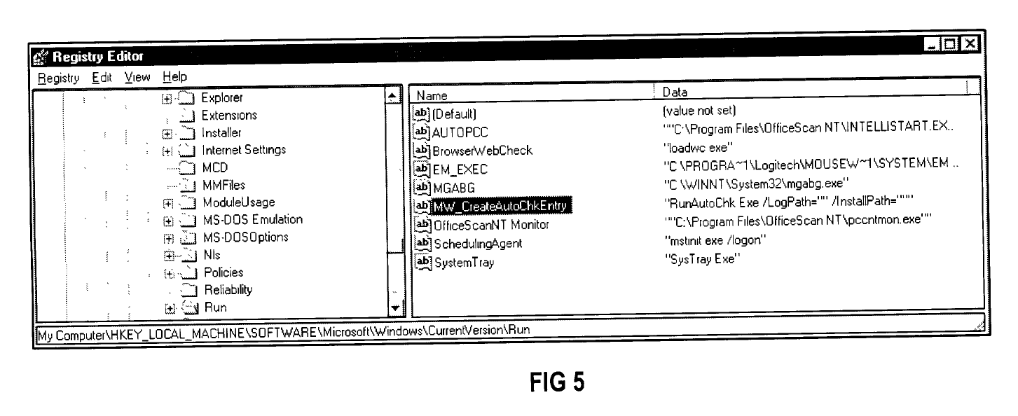

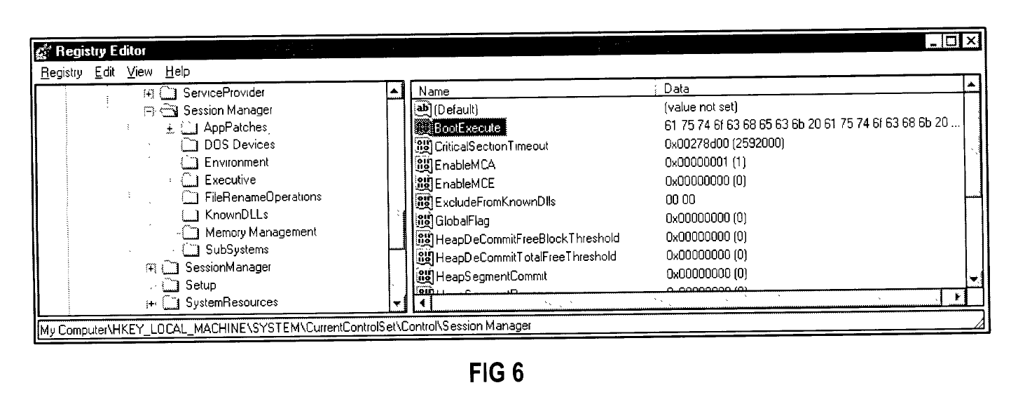

So that computer 42 can monitor computer 41, computer 41 is configured with a computer program which is added to the registry of computer 41's Windows NT® operating system as depicted in FIG. 5. FIG. 5 shows a list of executable computer programs with which computer 41's Windows NT® operating system is configured. Among these computer programs is a computer program which is named “MW_CreateAutoChkEntry” for the exemplary embodiment, which is designed to automatically initiate the Windows' NT® scan function to automatically scan computer 41's hard disk 41a for bad blocks, when computer 41's operating system Windows NT® is booted. After computer 41 is configured with computer program “MW_CreateAutoChkEntry”, the Session Manager of the Windows' NT® registry, as illustrated in FIG. 6, is modified by the entry “BootExecute”.

The scan function is part of the Windows NT® operating system and can also be manually initiated. Furthermore, Windows NT® is booted, for instance, when computer 41 is turned on. Thus, computer 41's hard disk 41a is checked for bad blocks whenever computer 41 is turned on.

The scan function is further designed to automatically report the result of the scan in the system logfile of the Windows NT® operating system. In order to remotely monitor computer 41, its agent is configured to check the system logfile and to generate an event report if at least one bad block has been detected by the scan. The event report contains information about the discovered bad block and is conveyed to the manager of the NMS 42 over the communication network 43. The manager of the NMS 42 receives the event report, interprets the message of the event report, and alerts an operator of the NMS 42 in a way generally known in the art. The operator is not shown in the Figures.

An exemplary source code of the computer program “MW_CreateAutoChkEntry” which is written in PERL for the present exemplary embodiment may have the following source code:

```
###################################################################
##############################################
# Run AutoChk in BlueScreen mode
# (c) 2001 Siemens Medical Solutions
#
###################################################################
##############################################
# Version 1.0 25.07.2001
###################################################################
##############################################
# globale variables
$VersionNr = “1.0”;
$applicationname = “$ENV{‘TEMP’}\\RunAutoChk.exe”;
@time = localtime( );  # determine date
$host = Win32::NodeName;  # determine
computer name
#
************************************************************************************************
# PROGRAM
#
************************************************************************************************
use Win32::API;
use Win32::Registry;
use Win32::EventLog;
# Work up program parameter
CommandLineArgument(@ARGV);
if ($LogPath eq “”) { # Used LOG-PATH
    $LogFile = $ENV{‘TEMP’} . “\\RunAutoChk.Log”;
}
else {
    $LogFile = $LogPath . “\\RunAutoChk.Log”;
}
#
************************************************************************************************
# Determine all local drives
#
************************************************************************************************
%drives = GetDrives(3);  # determine DRIVE_FIXED
@ localdrives = (keys %drives);
@ localdrives = sort(@ localdrives);
#
************************************************************************************************
# Execute SCANDISK during systemstart
#
************************************************************************************************
RunAutoChk(\@localdrives, $LogFile);
    if($main::HKEY_LOCAL_MACHINE-
>Open(“Software\\Microsoft\\Windows\\CurrentVersion\\Run”, $nsm)){
        $nsm->SetValueEx(“MW_CreateAutoChkEntry”, 0, REG_SZ,
$applicationname . “/LogPath=\”“ . $LogPath . ”\“”);
    }
#
************************************************************************************************
# SUBROUTINES
#
************************************************************************************************
sub RunAutoChk {
###########################################################
# Execute SCANDISK (AutoChk)
###########################################################
# IN:
```

| | |
|---|---|
| # @localdrive | = All local drives |
| # $logfilename | = file where all will be logged |

```
###########################################################
# OUT:
###########################################################
    my $refdrives  = shift;
    my $logfilename  = shift;
    my @localdrive = @$refdrives;
    my ($drive, $commands, $allcommands) = (“”, “”, “”);
    my $nsm = “”;
    Protocol(“AutoChk”,“Info”, “Autocheck has been written to the registry (drives:
@localdrive).”, $logfilename);
    print “Autocheck has been written to the registry (drives: @localdrive).\n”;
    foreach $drive ( @localdrive) {
        $drive =˜ s/\\//g;
        $commands = “autocheck autochk /r\\??\\” . $drive . “\x00”;
        $allcommands .= $commands;
    }
    $allcommands .= “\x00”;
    if($main::HKEY_LOCAL_MACHINE-
>Open(“System\\CurrentControlSet\\Control\\Session Manager”, $nsm)){
        $nsm->SetValueEx(“BootExecute”, 0, REG_MULTI_SZ,
$allcommands);
    }
}
sub GetDrives {
###########################################################
# List of all local drives
###########################################################
# IN:
# 1. $Typ = drive type, with value
# DRIVE_UNKNOWN = 0
# DRIVE_NO_ROOT_DIR = 1
# DRIVE_REMOVABLE = 2
# DRIVE_FIXED = 3
# DRIVE_REMOTE = 4
# DRIVE_CDROM = 5
# DRIVE_RAMDISK = 6
###########################################################
# RETURN:
# 1. Hash: Key  = drives
#  Data  = drive description
###########################################################
    my $Typ = $_[0];
    my $GetLogicalDrives ∥= new Win32::API(“kernel32”, “GetLogicalDrives”, [],N
) or return;
    my %Drives; #drive hash
    my $xx; #Decrementer
    my $GetDriveType ∥= new Win32::API(“kernel32”, “GetDriveTypeA”, [P],N)
or return;
    my $GetVolumeInformation ∥= new Win32::API(“kernel32”,
“GetVolumeInformationA”, [P, P, N, P, P, P, P, N],N) or return;
    $AviableDrives = $GetLogicalDrives->Call( ); ## call available
drives
    for ($x=0; $x<=24; $x++) {
        if ( ($AviableDrives & 2**$x) ) {
            if ( $GetDriveType->Call(chr(65+$x) . “:\\”. “\0”) == $Typ) {
                my $lpRootPathName = chr(65+$x) . “:\\”;
                my $pVolumeNameBuffer = “\0”x255;
                my $nVolumeNameSize = 255;
                my $lpVolumeSerialNumber = “ ”x255;
                my $lpMaximumComponentLength = “ ”x255;
                my $lpFileSystemFlags = “ ”x255;
                my $lpFileSystemNameBuffer = “ ”x255;
                my $nFileSystemNameSize = 255;
                  #call drive description
                  $successfully = $GetVolumeInformation->Call($lpRootPathName,
$pVolumeNameBuffer, $nVolumeNameSize,
                $lpVolumeSerialNumber,
$lpMaximumComponentLength,
                  $lpFileSystemFlags,
$lpFileSystemNameBuffer, $nFileSystemNameSize);
                if ($successfully == 1) {
                    # if success
                    $xx = length($pVolumeNameBuffer)−1;
                  while (ord(substr($pVolumeNameBuffer, $xx,1)) == 0 && ($xx > 0)
) {
                    # cut spaces
                    chop($pVolumeNameBuffer);
                    $xx = length($pVolumeNameBuffer)−1;
                }
                #save drivename in hash
                $drives{chr(65+$x) . “:\\”} = $pVolumeNameBuffer;
            }
            else {
              # if error
              $drives{chr(65+$x) . “: \\”} = “No drives available”;
            }
          }
      }
    }
    #return hash
    return (%drives);
}
sub OpenEventLog {
###########################################################
# Opening of NT-Event-Logs
###########################################################
# IN:
# 1. $ComputerName = computername
# 2. $SourceName = (system, application or security)
###########################################################
# RETURN:
###########################################################
    my $Computername = shift;
    my $SourceName = shift;
    %event=(
        ‘Length’,NULL,
        ‘RecordNumber’,NULL,
        ‘TimeGenerated’,NULL,
        ‘TimeWritten’,NULL,
        ‘EventID’,NULL,
        ‘EventType’,NULL,
        ‘Category’,NULL,
        ‘ClosingRecordNumber’,NULL,
        ‘Source’,NULL,
        ‘Computer’,NULL,
        ‘Strings’,NULL,
        ‘Data’,NULL,
    );
    Win32::EventLog::Open($EventLog, $SourceName, $Computername) ∥
NSM::Common Error(“Can't open Eventlog\”);
    $EventLog->GetNumber($count);
}
sub WriteEventLog {
###########################################################
# Write in NT-Event-Logs
###########################################################
# IN:
# 1. $Computer  = computername
# 2. $Source = source in EventLog
# 3. $EventType  = Type in EventLog e.g. EVENTLOG_ERROR_TYPE or
EVENTLOG_WARNING_TYPE
# 4. $Category  = Category e.g. EVENTLOG_ERROR_TYPE or
EVENTLOG_WARNING_TYPE
# 5. $EventID  = EventID in EventLog
# 6. $Data  = Data
# 7. $String  = String in der EventLog
###########################################################
# RETURN:
###########################################################
    my ($Computer,$Source,$EventType,$Category,$EventID, $Data, $String) =
@_;
    %NewTestEvent=(
        ‘Computer’, $Computer,
        ‘Source’, $Source,
        ‘EventType’, $EventType,
        ‘Category’, $Category,
        ‘EventID’, $EventID,
        ‘Data’, $Data,
        ‘Strings’, $String,
    );
    $EventLog->Report(\%NewTestEvent);
}
sub Protocol {
###########################################################
# Logging in a LOG-file with time stamp
###########################################################
# IN:
# 1. Program name
# 2. Errortype
# 3. Errortext
# 4. Filename  = e.g. SrvW_$DokuName.dat
###########################################################
#OUT:
###########################################################
    my $programname = shift;
    my $errortype = shift;
    my $errortext = shift;
    my $filename = shift;
    # unless (-d “$LogPath”) {
    # \grave{ }md $LogPath\grave{ };
    # }
    if(open (OUTLOG, “>>$LogFile”)) {
        # Protocol -> LOG
        my @time = localtime( );
determine date
        printf OUTLOG (“%02u.%02u.%04u %02u:%02u:%02u;%12s;%-
12s;%-7s;%-s\n” ,${time[3]}, ${time[4]} + 1, ${time[5]} + 1900, ${time[2]},
${time[1]},${time[0]}, $host, $programname, $errortype, $errortext);
        close (OUTLOG);
    }
}
sub CommandLineArgument {
# ***********************************************************
# Work up command line argument
# ***********************************************************
    my ($switch, $temp) = “”;
    foreach $switch (@ARGV) {
        if ($switch =˜ /\/LogPath=/i) {
            ($temp, $LogPath) = split (/=/, $switch);
            chomp $LogPath;
            $LogPath =˜ s/\\$//;  # delete last \ at logpath input
        }
        if ($switch =˜ /\help/i ∥ $switch =˜/\/\?/i) {
            HelpView( );
            exit;
        }
        if ($switch =˜ /\/v/i) {
            print “\nVersion $VersionsNr\n”;
            exit;
        }
    }
}
sub HelpView {
    print “(c) 2001 Siemens Medical Solutions -ZX CS SD 1 MW\n\n”;
    print “Run the Autochk-Tool after a reboot in the blue-screen.\n\n”;
    print “usage: RunAutoChk [/LogPath=Path to Log-File] [/?]\n\n”;
    print “/LogPath=Path  Path to Log-File (Default = $ENV{‘TEMP’}).\n”;
    print “/? Display this help-page.\n”;
    print “/Help  Display this help-page.\n\n”;
    }
```

Subroutine “RunAutoChk” initiates the scan of hard disk 41a when computer 41's Windows NT® operating system is booted. Subroutine “WriteEventLog” defines the result of the scan written in the event logfile of computer 41's Windows NT® operating system. The event logfile is a part of Windows' NT® system logfile.

For the exemplary embodiment, the computer program “MW_CreateAutoChkEntry” comprises further a subroutine “Protocol” which is designed, if activated, to report the result of the scan in a further file which is not associated with Windows' NT® logfile. If the result of the scan is written in that file and the contents of that file are used to retrieve information about a bad block of hard disk 41a, then the agent of computer 41 has to be configured to read this file.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method, comprising the steps of:
booting a first computer which is run by a Microsoft Windows® operating system;
based on a modified registry of said Microsoft Windows® operating system of said first computer, automatically initiating a scan for bad blocks of a hard disk which is associated with said first computer;
reporting the result of said scan in a file associated with said first computer;
generating, at said first computer, a message containing information about said at least one bad block if said at least one bad block is reported in said file; and
sending said message to a second computer over a communication network.

2. The method of claim 1, said file being a system logfile of said Microsoft Windows® operating system.

3. The method of claim 1, comprising monitoring said first computer with said second computer with an agent-manager network management system, so that said message is an event report generated by said agent-manager network management system.

4. The method of claim 1, wherein said Microsoft Windows® operating system is Windows 2000®, Windows XP®, or Windows NT®.

5. A first computer,
which is monitored by a second computer over a communication network;
said first computer being configured with a Microsoft Windows® operating system;
the registry of said first computer's said Microsoft Windows® operating system being modified, so that a function of said Microsoft Windows® operating system is automatically initiated when booting said first computer's said Microsoft Windows® operating system;
said function being designed to scan a hard disk associated with said first computer for bad blocks;
said first computer being configured to generate a message if at least one bad block of said hard disk is detected during said scan and said message comprising information about said at least one bad block; and
said first computer being configured to convey said message to said second computer over said communication network.

6. The first computer of claim 5, wherein said first computer being configured with an agent and said second computer being configured with a manger, so that said message is an event report generated by said agent.

7. The first computer of claim 6, wherein said Microsoft Windows® operating system is Windows 2000®, Windows XP®, or Windows NT®.

8. A computer program for configuring a computer which is run by a Microsoft Windows® operating system; said computer program being designed to modify the registry of said Microsoft Windows® operating system, so that said Microsoft Windows® operating system automatically initiates a scan of said computer's hard disk for bad blocks when said Microsoft operating system is booted and to record the results of said scan in a file associated with said computer.

9. The computer program of claim 8, said file being a system logfile of said Microsoft Windows® operating system.

10. The computer program of claim 8, wherein said Microsoft Windows® operating system is Windows 2000®, Windows XP®, or Windows NT®.
